(19) United States
(12) Patent Application Publication
(10) Pub. No.: US 2014/0103220 A1
(43) Pub. Date: Apr. 17, 2014

(54) RADIOGRAPHIC IMAGING APPARATUS

(71) Applicant: FUJIFILM Corporation, Tokyo (JP)

(72) Inventors: Yasunori OHTA, Ashigarakami-gun (JP); Naoyuki NISHINO, Ashigarakami-gun (JP); Naoto IWAKIRI, Ashigarakami-gun (JP); Haruyasu NAKATSUGAWA, Ashigarakami-gun (JP); Kouichi KITANO, Ashigarakami-gun (JP)

(73) Assignee: FUJIFILM Corporation, Tokyo (JP)

(21) Appl. No.: 14/136,873

(22) Filed: Dec. 20, 2013

Related U.S. Application Data
(63) Continuation of application No. PCT/JP2012/064039, filed on May 31, 2012.

(30) Foreign Application Priority Data
Jul. 27, 2011 (JP) 2011-164279

(51) Int. Cl. G01T 1/16

(52) U.S. Cl. CPC G01T 1/1603
USPC 250/366; 250/361 R

(57) ABSTRACT

An electronic cassette includes a first radiation detector for still imaging and a second radiation detector for fluoroscopic imaging. The first radiation detector includes a first photo detection device and a luminous device. The luminous device generates visible light by absorbing radiation transmitted through the first photo detection device. The first radiation detector detects the visible light generated by the luminous device. The second radiation detector is constituted by the luminous device and a second photo detection device disposed downstream of the luminous device in an optical path direction of the radiation. The second photo detection device detects the visible light generated by the luminous device. The second radiation detector is changed over to the first radiation detector, so that still imaging can be started by rapid setting during operation of fluoroscopic imaging.

### BACKGROUND OF THE INVENTION

1. Field of the Invention

The present invention relates to a radiographic imaging apparatus capable of fluoroscopic imaging and still imaging.

2. Description Related to the Prior Art

A radiographic imaging apparatus is known in the field of medicine, and images a body part of a patient as an object by use of radiation (for example, X-rays). The radiographic imaging apparatus includes a radiation source and a radiation detector. The radiation source applies radiation (X-rays) to the object. The radiation detector is opposed to the radiation source, and detects the radiation transmitted through the object for creating a radiation image.

There is a type of the radiographic imaging apparatus in which both of fluoroscopic imaging and still imaging can be carried out. To this end, a radiation dose of radiation to be emitted by the radiation source is set different between the fluoroscopic imaging and still imaging. The fluoroscopic imaging is carried out with a low dose of radiation, for positioning a patient for the still imaging, and seeking for a lesion in a body part of the patient, and the like. The still imaging is carried out with a high dose of radiation for sharply creating a radiation image of the lesion. It is known that a level of the radiation dose of the still imaging is approximately 100 times as high as a level of the radiation dose of the fluoroscopic imaging.

In the radiographic imaging apparatus changeable over between the fluoroscopic imaging and still imaging, it is necessary to set a driving mode of the radiation detector according to either one of the fluoroscopic imaging and still imaging. To facilitate the setting of the driving mode, U.S. Pat. No. 6,891,923 (corresponding to JP-A 2003-307596) discloses monitoring a dose of radiation emitted by the radiation source at the radiation detector, and changeover of the radiation detector from a fluoroscopic imaging mode to a still imaging mode in response to the changeover from the low dose to the high dose. Therefore, the driving mode of the radiation detector can be changed even without sending or receiving a sync signal between the radiation source and the radiation detector.

However, the radiographic imaging apparatus disclosed in U.S. Pat. No. 6,891,923 carries out the fluoroscopic imaging and still imaging by use of the radiation detector. Image quality, a field of view and the like cannot be changed over between the fluoroscopic imaging and still imaging. In JP-A 2002-102213 and 2011-004966, the radiographic imaging apparatus including a first radiation detector for the still imaging and a second radiation detector for the fluoroscopic imaging with a smaller field of view than the first radiation detector is disclosed. At the time of the still imaging, the second radiation detector is shifted away from an optical path of radiation from the radiation source for the first radiation detector to operate for the still imaging.

However, the radiographic imaging apparatus of JP-A 2002-102213 and 2011-004966 has a problem of requiring mechanical movement of the second radiation detector away from the optical path of the radiation at the time of the still imaging with the first radiation detector by interrupting the fluoroscopic imaging with the second radiation detector. The still imaging cannot be rapidly started during the fluoroscopic imaging, so that an image of the body part with good opportunity cannot be formed suitably in the sequence of time.

### SUMMARY OF THE INVENTION

In view of the foregoing problems, an object of the present invention is to provide a radiographic imaging apparatus capable of rapidly setting for still imaging during operation of fluoroscopic imaging.

In order to achieve the above and other objects and advantages of this invention, a radiographic imaging apparatus includes a first radiation detector for detecting radiation emitted by a radiation source, and creating image data. A second radiation detector detects the radiation transmitted through the first radiation detector, and creating image data. A controller controls the first and second radiation detectors, to operate the first radiation detector for still imaging, and to operate the second radiation detector for fluoroscopic imaging.

Preferably, furthermore, a measurement unit measures a dose of radiation pulses of the radiation emitted by the radiation source. An evaluator compares the dose measured by the measurement unit to a predetermined threshold. The controller, if the dose of the radiation pulses is found lower than the threshold by the evaluator, operates the second radiation detector for fluoroscopic imaging, and if the dose of the radiation pulses is found higher than the threshold by the evaluator, operates the first radiation detector for still imaging.

Preferably, each of the first and second radiation detectors has plural pixels. Arrangement density of the pixels of the second radiation detector is lower than arrangement density of the pixels of the first radiation detector.

Preferably, a pixel number of the pixels of the second radiation detector is smaller than a pixel number of the pixels of the first radiation detector.

Preferably, a frame rate of the second radiation detector is higher than a frame rate of the first radiation detector.

Preferably, a field of view of the second radiation detector is smaller than a field of view of the first radiation detector.

In another preferred embodiment, the first radiation detector includes a luminous device for emitting visible light by absorbing the radiation, and a first photo detection device disposed upstream of the luminous device in an optical path direction of the radiation for detecting the visible light emitted by the luminous device. The second radiation detector includes the luminous device, and a second photo detection device disposed downstream of the luminous device in the optical path direction for detecting the visible light emitted by the luminous device.

Preferably, the luminous device contains phosphor of a columnar crystal, and a distal end of the phosphor of the columnar crystal is opposed to the first photo detection device.

Preferably, an area of the second photo detection device is smaller than an area of the luminous device.

Preferably, each of the first and second radiation detectors has plural pixels. Arrangement density of the pixels of the second radiation detector is lower than arrangement density of the pixels of the first radiation detector.

Preferably, the second photo detection device is a CMOS image sensor or CCD image sensor.

In one preferred embodiment, furthermore, a Fresnel lens is disposed between the luminous device and the second photo detection device, for condensing the visible light from the luminous device toward the second photo detection device.

In still another preferred embodiment, the first radiation detector includes a first luminous device for emitting visible light by absorbing the radiation, and a first photo detection device disposed upstream of the first luminous device in an optical path direction of the radiation for detecting the visible light emitted by the first luminous device. The second radiation detector includes a second luminous device for emitting visible light by absorbing the radiation transmitted through the first luminous device and the first photo detection device, and a second photo detection device disposed downstream of the second luminous device in the optical path direction for detecting the visible light emitted by the second luminous device.

Preferably, one of the first and second luminous devices has phosphor of a columnar crystal, and a remaining one of the first and second luminous devices has phosphor of gadolinium oxide.

According to the radiographic imaging apparatus of the present invention, still imaging by rapid setting during operation of fluoroscopic imaging is enabled, because the second radiation detector is disposed behind the first radiation detector, the first radiation detector is used for still imaging, and the second radiation detector is used for fluoroscopic imaging.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating a Radiology Information System (RIS);

FIG. 2 is a side view illustrating arrangement of respective devices in a radiographic imaging system (or subsystem);

FIG. 3 is a perspective view partially broken, illustrating an electronic cassette;

FIG. 4 is a section schematically illustrating a structure of the electronic cassette;

FIG. 5 is a section illustrating a structure of a scintillator;

FIG. 6 is an explanatory view illustrating a structure of first and second radiation detectors and a measurement unit for dosimetry;

FIG. 7 is a block diagram illustrating electric arrangement of the electronic cassette;

FIG. 8 is a block diagram illustrating a radiation source and a console unit;

FIG. 9 is an explanatory view illustrating a sequence of the operation of the radiographic imaging system;

FIG. 10 is an explanatory view illustrating a first variant of electronic cassette;

FIG. 11 is an explanatory view illustrating a second variant of electronic cassette;

FIG. 12 is an explanatory view illustrating a third variant of electronic cassette;

FIG. 13 is an explanatory view illustrating a fourth variant of electronic cassette;

FIG. 14 is an explanatory view illustrating a fifth variant of electronic cassette;

FIG. 15 is an explanatory view illustrating a sixth variant of electronic cassette;

FIG. 16 is an explanatory view illustrating a seventh variant of electronic cassette.

### DETAILED DESCRIPTION OF THE PREFERRED

### Embodiment(s) of the Present Invention

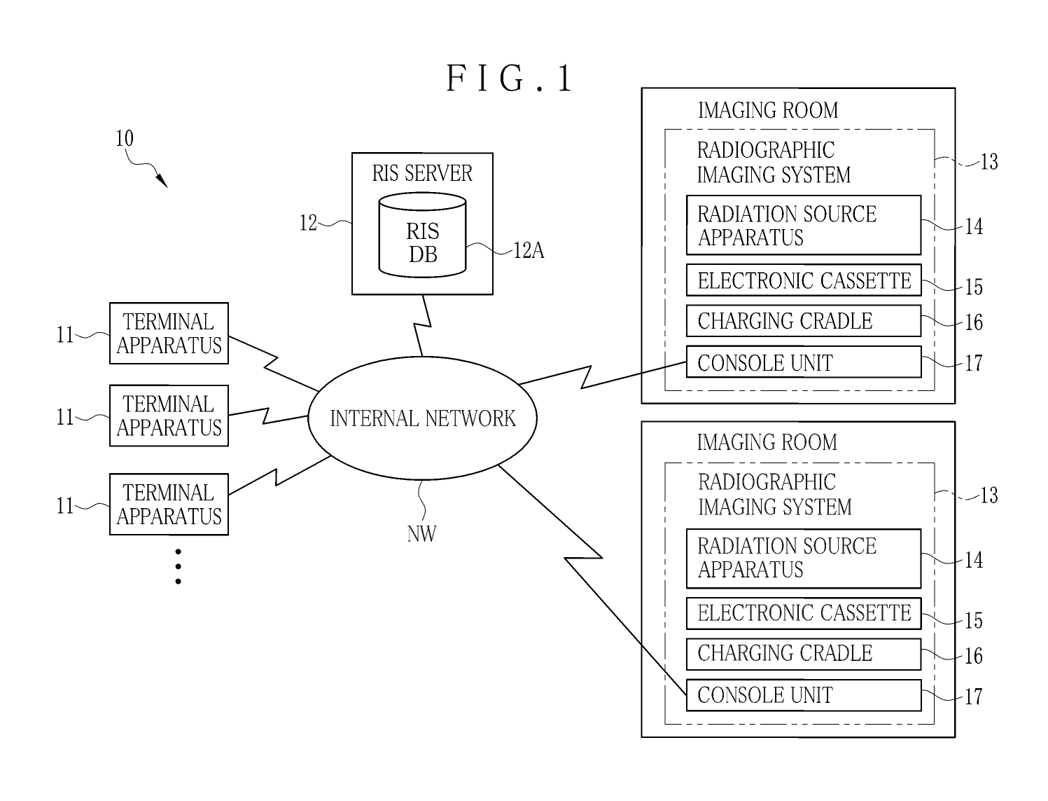

In FIG. 1, a Radiology Information System 10 (RIS) is a system for information management of a reservation of consultation and record of diagnosis in a radiology department in a hospital. The Radiology Information System 10 is constituted by plural terminal apparatuses 11, a RIS server 12 and a radiographic imaging system 13 (or subsystem) connected together to an internal network NW in a wired or wireless manner, the radiographic imaging system 13 being installed in each of imaging rooms for radiography (or surgical operation rooms) in the hospital.

An example of the terminal apparatuses 11 is a personal computer (PC), which is operated by an operator (doctor or radiology technician). The operator inputs or views diagnosis information and reservation of the radiographic imaging system 13 by operating the terminal apparatuses 11. A request for examination (reservation) of a radiation image is also input with the terminal apparatuses 11.

There is storage 12A in the RIS server 12 for storing RIS database (DB). The storage 12A stores attribute information of a patient, medical history information relevant to the patient, and cassette information related to an electronic cassette 15 provided in respectively the radiographic imaging system 13. The attribute information includes name, sex, birthday, age, blood type, patient ID, and the like of the patient. The medical history information includes medical history, diagnosis history, radiography history, image data of past radiation images, and the like of the patient. The cassette information includes a cassette number, type, size, sensitivity, target body part, date of unpacking, number of times of use, and the like of the electronic cassette 15. According to the registered information in the storage 12A, the RIS server 12 carries out processing to manage the entirety of the Radiology Information System 10 (for example, processing for receiving a request for imaging from respectively the terminal apparatuses 11 and managing a schedule for imaging in respectively the radiographic imaging system 13).

The radiographic imaging system 13 (or subsystem) creates a radiation image instructed by the RIS server 12 according to operation of a doctor or radiology technician. The radiographic imaging system 13 includes a radiation source apparatus 14, the electronic cassette 15, a charging cradle 16 and a console unit 17. The radiation source apparatus 14 generates radiation. The electronic cassette 15 detects radiation transmitted through a body part of the patient and creates the radiation image. The charging cradle 16 charges the electronic cassette 15. The console unit 17 controls the operation of those devices. The electronic cassette 15 is a portable type of radiographic imaging apparatus.

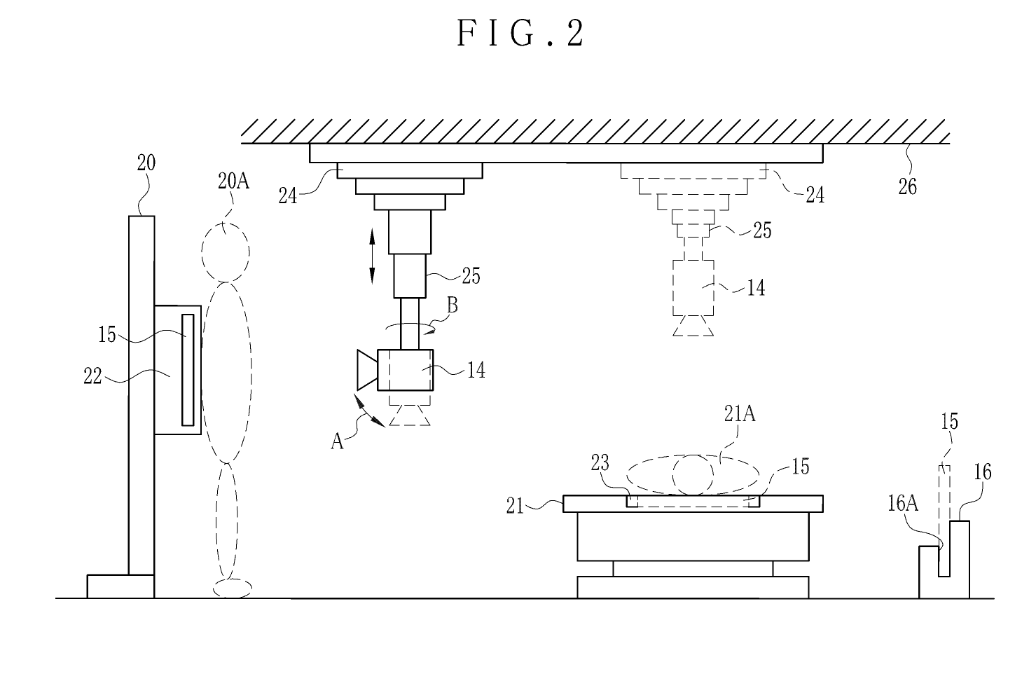

In FIG. 2, an imaging room contains the radiation source apparatus 14, an upright stand 20 and a horizontal table 21. The upright stand 20 is used for radiographic imaging (hereinafter referred to as standing imaging) of a body part of a standing patient 20A. The horizontal table 21 is used for radiographic imaging (hereinafter referred to as horizontal imaging) of a body part of a supine patient 21A. A cassette chamber 22 is formed in the upright stand 20 for mounting of the electronic cassette 15. At the time of the standing imaging, the electronic cassette 15 is held in the cassette chamber 22 of the upright stand 20. At the time of the horizontal imaging, a cassette chamber 23 in the horizontal table 21 is caused to contain the electronic cassette 15.

Also, a support/movement mechanism 24 is disposed in the imaging room for radiography, and moves in a two-dimensional manner along a ceiling 26 by supporting the radiation source apparatus 14 with an extendable support 25, so as to enable the standing imaging and the horizontal imaging only with the single radiation source apparatus 14. The extendable support 25 supports the radiation source apparatus 14 to enable the same to rotate about a horizontal axis (in a direction of the arrow A) and about a vertical axis (in a direction of the arrow B).

A containment channel 16A is formed in the charging cradle 16 for receiving the electronic cassette 15. The electronic cassette 15, while not used, is contained in the containment channel 16A, where an internal battery of the electronic cassette 15 is charged. At the time of imaging, the electronic cassette 15 is removed from the charging cradle 16 by an operator. The electronic cassette 15 is held by the cassette chamber 22 of the upright stand 20 for the standing imaging, or is contained in the cassette chamber 23 of the horizontal table 21 for the horizontal imaging.

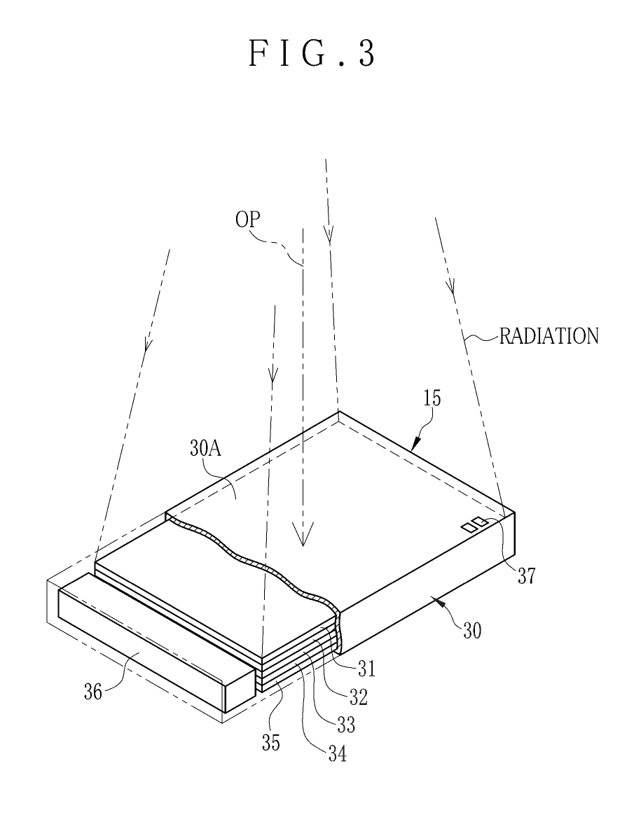

In FIG. 3, the electronic cassette 15 includes a housing 30, a radiation sensor 31 for dosimetry, a first photo detection device 32, a luminous device 33, a second photo detection device 34, a base support 35 and a container case 36. The radiation sensor 31 for dosimetry, the first photo detection device 32, the luminous device 33, the second photo detection device 34 and the base support 35 are placed on one another inside the housing 30 in a sequence in an optical path direction OP of radiation.

The housing 30 is formed from radio-transparent material, and is in a shape of a quadrangular prism. An upper plate 30A of the housing 30 is formed from a carbon as a material having a very low radiation absorption. Radiation passed through a body part of a patient is applied to the upper plate 30A. A portion of the housing 30 other than the upper plate 30A is formed form suitable material, such as ABS resin.

An indicator 37 is disposed on the upper plate 30A, is constituted by a plurality of light-emitting diodes (LEDs), and displays operating states, such as an operation mode (for example, “Ready state”, “During transmission of data”, and the like) of the electronic cassette 15, available capacity of a battery, or the like. Note that the indicator 37 may be a display device constituted by light emitting elements other than the LEDs, a liquid crystal display, an organic EL display, or any one of various known types of light valve displays. Also, the indicator 37 may be disposed in a portion other than the upper plate 30A.

The container case 36 is disposed along one end of the upper plate 30A as viewed in a longitudinal direction. The container case 36 contains a microcomputer (not shown) and a battery (not shown). The battery is chargeable and mounted in a removable manner. Plural electronic circuits of the electronic cassette 15 including the radiation sensor 31 for dosimetry, the first photo detection device 32 and the second photo detection device 34 are supplied with power from the battery for operation. A radiopaque plate (not shown), such as a plate of metal lead, is disposed on the side of the upper plate 30A of the container case 36 for preventing the electronic circuits from being damaged with radiation.

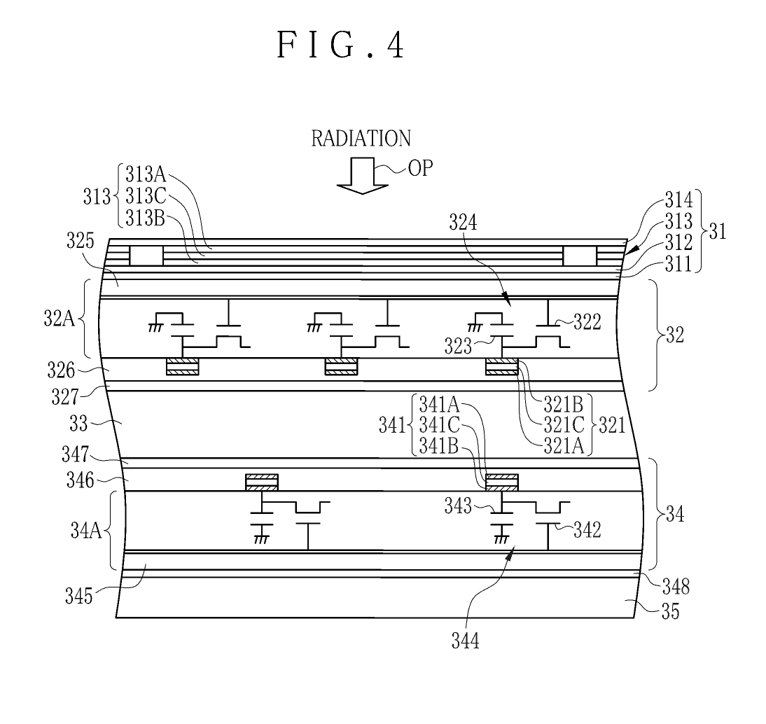

In FIG. 4, the first photo detection device 32 is constituted by forming a plurality of pixels 324 on an insulation board 325. The pixels 324 have a photoconductor 321 (photoelectric converter), a thin film transistor 322 (TFT) and a capacitor 323. The pixels 324 are arranged in a two-dimensional form of a matrix.

A TFT active matrix substrate plate 32A (TFT substrate) is constituted by the insulation board 325 and the layer having the thin film transistor 322 and the capacitor 323. The thin film transistor 322 is formed from amorphous silicon. The insulation board 325 is formed from material transparent to light and having low radiation absorption, such as a quartz substrate, glass substrate, resin substrate and the like.

The photoconductor 321 includes a first electrode 321A, a second electrode 321B and a photoconductive film 321C (photoelectric conversion film) disposed between those. The photoconductive film 321C is formed from amorphous silicon, and generates charge by absorbing visible light emitted by the luminous device 33 which will be described later. The photoconductor 321 operates as a photo diode of a PIN or MIS type, and is disposed on the TFT active matrix substrate plate 32A. A planarization layer 326 is formed on the TFT active matrix substrate plate 32A to cover the photoconductor 321. The planarization layer 326 is formed from silicon nitride or silicon oxide, in which a downstream surface in the optical path direction OP is planarized.

The second photo detection device 34 is constructed similarly to the first photo detection device 32, and includes pixels 344 arranged on an insulation board 345 two-dimensionally in plural arrays. The pixels 344 have a photoconductor 341, a thin film transistor 342 (TFT) and a capacitor 343. A pitch of arrangement of the pixels 344 of the second photo detection device 34 is larger than that of the pixels 324 of the first photo detection device 32, and thus the pixels 344 have a smaller density of the arrangement.

The photoconductor 341 includes a first electrode 341A, a second electrode 341B and a photoconductive film 341C disposed between those. A planarization layer 346 is formed to cover the photoconductor 341. An upstream surface of the planarization layer 346 in the optical path direction OP is planarized. A TFT active matrix substrate plate 34A is constituted by the insulation board 345 and the layer of forming the thin film transistor 342 and the capacitor 343.

The sequence of positioning the elements of the second photo detection device 34 is opposite to that of the elements of the first photo detection device 32 in relation to the optical path direction OP of radiation. In short, the planarization layer 326 of the first photo detection device 32 is opposed to the planarization layer 346 of the second photo detection device 34. The luminous device 33 is disposed between those. The luminous device 33 emits visible light in response to entry of radiation.

An adhesive layer 327 with transparency attaches the planarization layer 326 of the first photo detection device 32 to the luminous device 33. Similarly, an adhesive layer 347 with transparency attaches the planarization layer 346 of the second photo detection device 34 to the luminous device 33. An adhesive layer 348 attaches the insulation board 345 of the second photo detection device 34 to the base support 35.

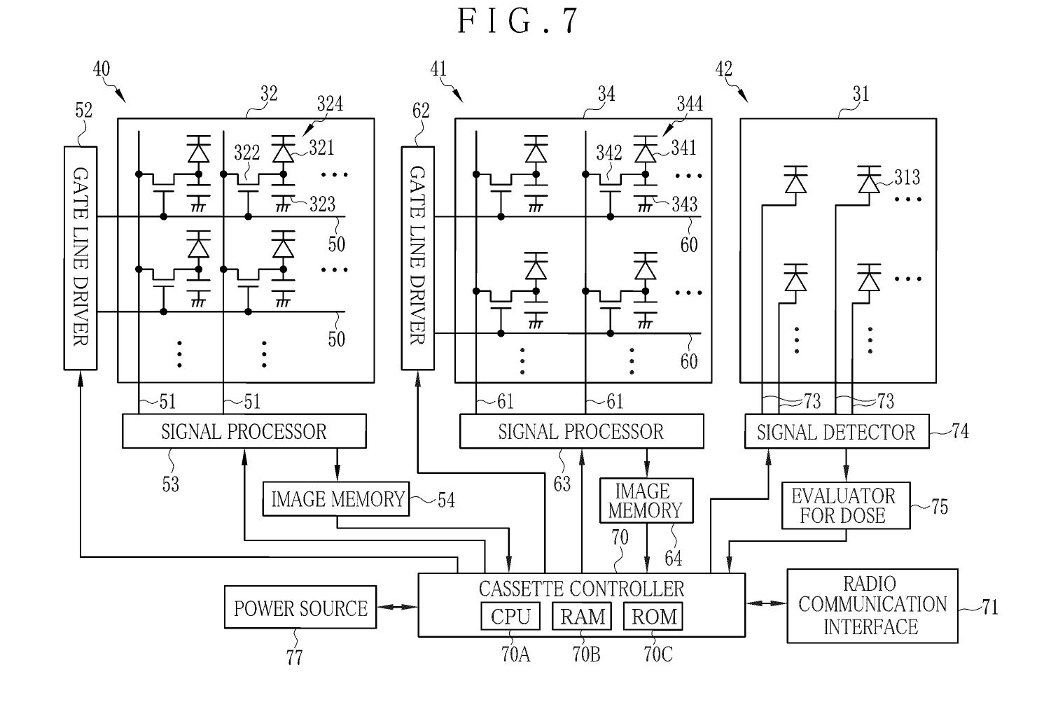

The radiation sensor 31 for dosimetry is formed on an upstream surface of the first photo detection device 32 in the optical path direction OP. In the radiation sensor 31 for dosimetry, there are a wiring layer 311, an insulating layer 312, photoconductors 313 and a protection layer 314 formed on the insulation board 325 in a sequence. In the wiring layer 311, wire lines 73 (see FIG. 7) are patterned on an insulation board 315 to be described later. The photoconductors 313 are elements for detecting visible light emitted by the luminous device 33 and transmitted through the first photo detection device 32. A plurality of the photoconductors 313 are formed on the insulating layer 312 in plural arrays. A thickness of the radiation sensor 31 for dosimetry is as large as 0.05 mm.

Each of the photoconductors 313 includes a first electrode 313A, a second electrode 313B and a photoconductive film 313C disposed between those. The photoconductive film 313C is formed from an organic photoconductive material. The photoconductive film 313C is formed by coating the second electrode 313B with the organic photoconductive material by use of an ink jet head and the like.

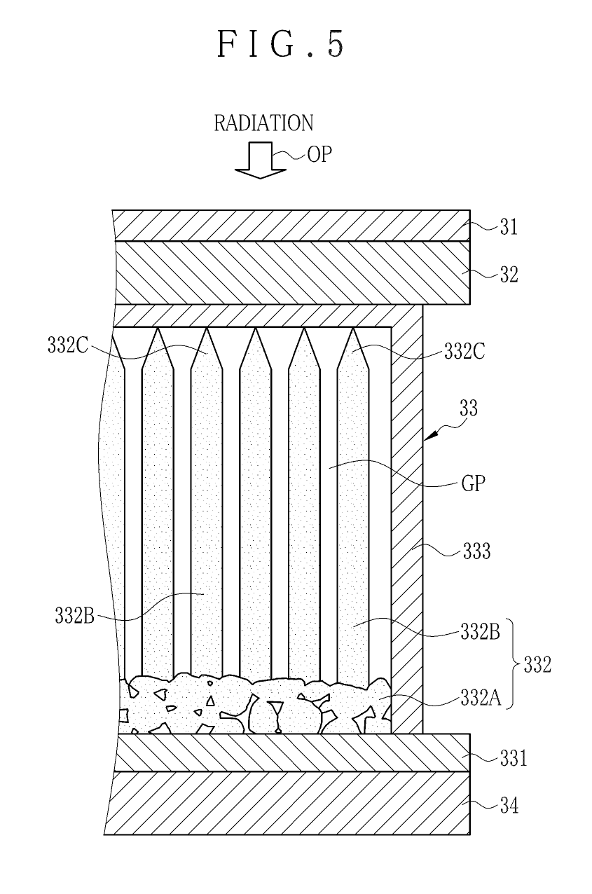

In FIG. 5, the luminous device 33 is constituted by a deposition substrate 331 of vapor deposition, a scintillator 332 and a moisture proof protection film 333. The deposition substrate 331 is a transparent substrate such as a quartz substrate, glass substrate, resin substrate and the like. The scintillator 332 is formed by vapor deposition of thallium-activated cesium iodide (CsI:Tl) as phosphor on the deposition substrate 331. The scintillator 332 is constituted by a non-columnar crystal 332A and a plurality of columnar crystal structures 332B extending from the non-columnar crystal 332A. The moisture proof protection film 333 is formed from a moisture proof material such as polyparaxylene, and covers the periphery of the scintillator 332.

Note that the deposition substrate 331 may not be disposed. For example, the deposition substrate 331, after forming the scintillator 332 on the deposition substrate 331, can be peeled from the scintillator 332, so that the scintillator 332 can be attached to the second photo detection device 34. Alternatively, the scintillator 332 can be formed on the second photo detection device 34 by direct vapor deposition. Also, phosphor materials such as sodium-activated cesium iodide (CsI:Na) may be used in place of CsI:Tl.

The scintillator 332 is so disposed that a distal end 332C of the columnar crystal structures 332B is opposed to the first photo detection device 32. The deposition substrate 331 is attached to the second photo detection device 34 with adhesive agent or the like. The columnar crystal structures 332B are disposed with gaps GP discretely. A diameter of each of the columnar crystal structures 332B is in a range from several microns to tens of microns.

Radiation is emitted by the radiation source apparatus 14, passes a body of the patient, the upper plate 30A, the radiation sensor 31 for dosimetry, the first photo detection device 32 and the like, and enters the luminous device 33. The scintillator 332 absorbs the radiation and generates visible light. As the radiation enters the scintillator 332 on a side of the first photo detection device 32, light emission in the scintillator 332 occurs mainly in a position of the columnar crystal structures 332B on a side of the distal end 332C. The visible light generated in the scintillator 332 travels toward the first and second photo detection devices 32 and 34 according to effect of a light guide of the columnar crystal structures 332B.

The visible light traveling to the first photo detection device 32 exits from the distal end 332C, enters the first photo detection device 32 after transmission through the moisture proof protection film 333, and is detected by the photoconductor 321 of the first photo detection device 32. Part of the visible light entered in the first photo detection device 32 is transmitted through the first photo detection device 32 and enters the radiation sensor 31 for dosimetry. The visible light entered in the radiation sensor 31 for dosimetry is detected by the photoconductors 313.

Visible light having traveled toward the second photo detection device 34 enters the non-columnar crystal 332A and is partially reflected by the non-columnar crystal 332A. However, most of the visible light is passed through the deposition substrate 331 and enters the second photo detection device 34. The visible light having entered the second photo detection device 34 is detected by the photoconductor 341.

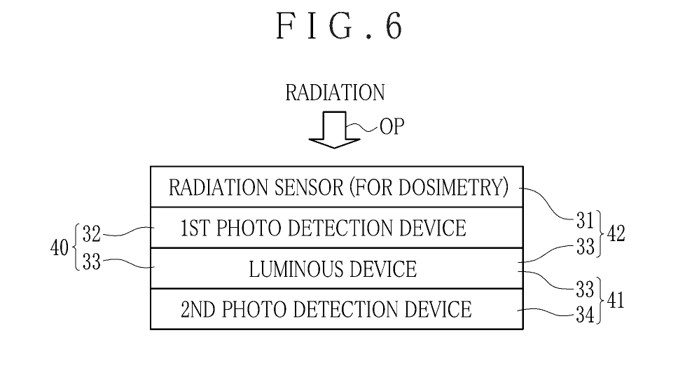

As illustrated in FIG. 6, a first radiation detector 40 is constituted by the luminous device 33 and the first photo detection device 32. In the first radiation detector 40, the first photo detection device 32 and the luminous device 33 are arranged in series in the optical path direction OP of radiation. This type of the arrangement is referred to as a type of “Irradiation Side Sampling (ISS)”. Also, a second radiation detector 41 is constituted by the luminous device 33 and the second photo detection device 34. In the second radiation detector 41, the luminous device 33 and the second photo detection device 34 are arranged in series in the optical path direction OP of radiation. This type of the arrangement is referred to as a type of “Penetration Side Sampling (PSS)”.

Also, a measurement unit 42 for dosimetry of the ISS type is constituted by the luminous device 33 and the radiation sensor 31 for dosimetry. As described heretofore, light emission in the scintillator 332 of the luminous device 33 occurs in the vicinity of the first photo detection device 32. An image is detected by the first radiation detector 40 at a large light amount and high precision.

The first radiation detector 40 is used for still imaging. The second radiation detector 41 is used for fluoroscopic imaging. In the second radiation detector 41, a pitch of arrangement of the pixels 344 is larger than that of the pixels 324 in the first radiation detector 40. The number of the pixels 344 (the number of active pixels) is smaller, so that the pixels 344 are driven at a high frame rate.

In FIG. 7, the first photo detection device 32 has a plurality of gate wire lines 50 and a plurality of data wire lines 51. The gate wire lines 50 extend in the array direction and turn on and off the thin film transistors 322. The data wire lines 51 extend in a column direction transverse to the array direction, and read out the charge stored in the capacitors 323 through the thin film transistors 322 in a turn-on state. Also, the first radiation detector 40 includes a gate line driver 52, a signal processor 53 and an image memory 54 in addition to the first photo detection device 32.

The gate wire lines 50 are connected to the gate line driver 52. The data wire lines 51 are connected to the signal processor 53. In case radiation passed through a body part of a patient (radiation with image information of the body part) is applied to the electronic cassette 15, the luminous device 33 emits visible light at a light amount according to a dose of the radiation. The photoconductor 321 of the pixels 324 generates charge at an amount according to a light amount of the incident visible light. The charge is stored by the capacitor 323.

As the charge is stored in the capacitor 323, the thin film transistors 322 are turned on sequentially by the unit of arrays according to a signal supplied by the gate line driver 52 through the gate wire lines 50. The charge stored in the capacitor 323 of the pixels 324 of which the thin film transistors 322 are turned on is transmitted by the data wire lines 51 as an analog electric signal and input to the signal processor 53. In this manner, the charge stored in the capacitor 323 of the pixels 324 is read out by the unit of arrays.

The signal processor 53 includes amplifiers (not shown) and sample-hold circuits (not shown) for each of the data wire lines 51. Electric signals transmitted by respectively the data wire lines 51 are amplified by the amplifiers, and held by the sample-hold circuits. To outputs of the sample-hold circuits, a multiplexer (not shown) and an A/D converter (not shown) are connected in series. The electric signals held by the sample-hold circuits are selected by the multiplexer, and converted into digital image data by the A/D converter. The image memory 54 is connected to the signal processor 53. The image data output by the A/D converter of the signal processor 53 is written to the image memory 54.

Similarly, the second photo detection device 34 has a plurality of gate wire lines 60 and a plurality of data wire lines 61. The second radiation detector 41 includes a gate line driver 62, a signal processor 63 and an image memory 64 in addition to the second photo detection device 34. The gate wire lines 60 are connected to the gate line driver 62. The data wire lines 61 are connected to the signal processor 63. Also, the image memory 64 is connected to the signal processor 63.

As described heretofore, the pixels 344 of the second photo detection device 34 are arranged at a small density. The number of the gate wire lines 60 and the data wire lines 61 is smaller than that of the gate wire lines 50 and the data wire lines 51 of the first photo detection device 32. In the second radiation detector 41 for the purpose of fluoroscopic imaging, an output gain of the amplifier in the signal processor 63 is set higher than that of the amplifier in the signal processor 53 for the first radiation detector 40. Except for those differences, the first radiation detector 40 is repeated in the second radiation detector 41.

A cassette controller 70 controls the entirety of the electronic cassette 15. The image memory 54, 64 is connected to the cassette controller 70. The cassette controller 70 includes a microcomputer, and has a CPU 70A, a RAM 70B and a ROM 70C, which is a non-volatile memory such as a flash memory.

A radio communication interface 71 is provided on the cassette controller 70 for wireless transmission and reception of various data in connection with an external device. The radio communication interface 71 is according to the standards of the wireless LAN (local area network), such as IEEE 802.11a, IEEE 802.11b, IEEE 802.11g and IEEE 802.11n. The cassette controller 70 wirelessly communicates with the console unit 17 by means of the radio communication interface 71.

The measurement unit 42 for dosimetry is used for measuring a dose of radiation applied by the radiation source apparatus 14 to the electronic cassette 15. The radiation source apparatus 14 emits pulses of a low dose for fluoroscopic imaging and pulses of a high dose for still imaging as radiation according to manipulation of an operator.

The wire lines 73 are disposed on the radiation sensor 31 for dosimetry of the measurement unit 42 for dosimetry. The number of the wire lines 73 is equal to that of the photoconductors 313. The measurement unit 42 for dosimetry has a signal detector 74 in addition to the radiation sensor 31 for dosimetry. The photoconductors 313 are connected to the signal detector 74 by the wire lines 73 which are discrete from one another. The signal detector 74 has amplifiers, sample-hold circuits and A/D converters (all not shown) for respectively the wire lines 73. The signal detector 74 is connected to an evaluator 75 for the dose and the cassette controller 70.

The signal detector 74 is controlled by the cassette controller 70 and periodically samples a signal transmitted from the photoconductors 313 by the wire lines 73 at a predetermined period. The signal detector 74 converts the sampled signal into digital data and outputs this to the evaluator 75 for the dose serially. The evaluator 75 for the dose determines a dose of radiation emitted by the radiation source apparatus 14 according to the data input from the signal detector 74 (or determines which of low dose radiation pulses for fluoroscopic imaging and high dose radiation pulses for still imaging). A result of the determination is output to the cassette controller 70.

A power source 77 is provided in the electronic cassette 15, and connected to the above-described electronic circuits by wire lines (not shown). The battery described above is incorporated in the power source 77 in a form of keeping portability of the electronic cassette 15, and supplies the electronic circuits with power. The power source 77 is connected to the cassette controller 70. Supply of power to the first and second radiation detectors 40 and 41 is changeable over between a turn-on state and turn-off state by the cassette controller 70.

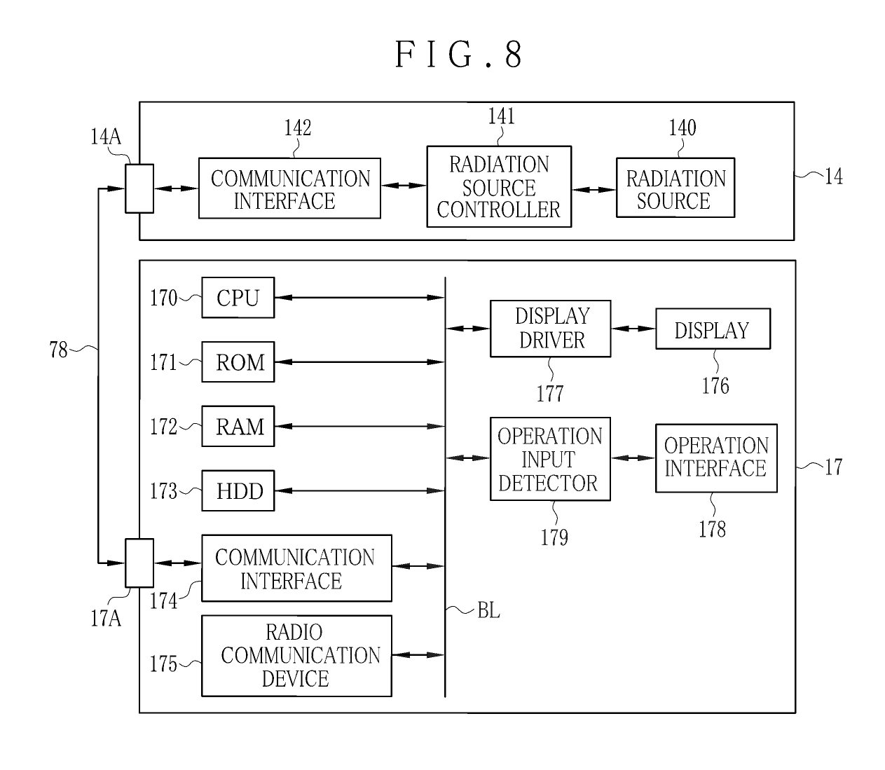

In FIG. 8, the console unit 17 is constituted by a computer and includes a CPU 170, a ROM 171, a RAM 172 and an HDD 173. The CPU 170 controls the entirety of the apparatus. The ROM 171 previously stores various programs and the like including a control program. The RAM 172 stores various data in a temporary manner. The HDD 173 stores the various data. Those are interconnected with a bus line BL. A communication interface 174 and a radio communication device 175 are connected with the bus line BL, with which a display 176 is connected in cooperation with a display driver 177. Furthermore, an operation interface 178 is connected with the bus line BL in cooperation with an operation input detector 179.

The communication interface 174 is connected to a connection terminal 14A of the radiation source apparatus 14 by means of a connection terminal 17A and a transmission cable 78. The CPU 170 with the communication interface 174 sends and receives information such as an emission condition in connection with the radiation source apparatus 14. The radio communication device 175 wirelessly communicates with the radio communication interface 71 of the electronic cassette 15. The CPU 170 with the radio communication device 175 sends and receives information including image data in connection with the electronic cassette 15.

The display driver 177 forms and outputs a signal for the display 176 to display various data. The CPU 170 controls the display driver 177 to cause the display 176 to display an operation menu, radiation image and the like. The operation interface 178 is constituted by a keyboard and the like, for inputting various data and operation command. The operation input detector 179 detects external operation to the operation interface 178, and sends a result of the detection to the CPU 170. A foot switch (not shown) is connected to the operation input detector 179, is disposed on a floor of the imaging room, and changes over between the fluoroscopic imaging and still imaging. The foot switch is turned on and off in case depressed by a foot of the operator.

The radiation source apparatus 14 includes a radiation source 140, a communication interface 142 and a radiation source controller 141. The radiation source 140 generates radiation. The communication interface 142 sends and receives various data such as emission condition in connection with the console unit 17. The radiation source controller 141 controls the radiation source 140 according to the emission condition received from the console unit 17.

The operation of the Radiology Information System 10 is described next. If imaging of a radiation image is wished, information of an examination request is input with one of the terminal apparatuses 11. In the examination request, a patient and body parts are specified as an object of imaging. Also, a tube voltage and tube current are designated as required.

The terminal apparatus 11 notifies the RIS server 12 of the input information of the examination request. The RIS server 12 writes the information of the examination request from the terminal apparatus 11 to the storage 12A. The console unit 17 retrieves the information of the examination request and attribute information of a patient by accessing the RIS server 12, and causes the display 176 to display the examination request and the attribute information of the patient.

The operator views the information of the examination request displayed on the display 176, and prepares for imaging of a radiation image. In the case of the supine patient 21A lying on the horizontal table 21, the electronic cassette 15 is set in the cassette chamber 23 of the horizontal table 21.

In case the preparation is completed, the operator manipulates the operation interface 178 of the console unit 17 for notifying completion of the preparation. In response to this, the console unit 17 changes over the electronic cassette 15 to a ready state as an operation mode. In the ready state of the electronic cassette 15, the cassette controller 70 drives the measurement unit 42 for dosimetry and the evaluator 75 for the dose and starts a waiting operation for detecting radiation pulses (low dose radiation pulses or high dose radiation pulses) emitted by the radiation source apparatus 14. The console unit 17 notifies the operator of the readiness for imaging by changing over the display 176.

The operator having checked the notice instructs imaging with the operation interface 178. At the time of still imaging, for example, the console unit 17 transmits a command signal to the radiation source apparatus 14 to instruct a start of radiation. The radiation source apparatus 14, according to a tube voltage and tube current according to an emission condition received from the console unit 17, emits high dose radiation pulses for the still imaging.

In case the measurement unit 42 for dosimetry and the evaluator 75 for the dose detect the high dose radiation pulses, the cassette controller 70 of the electronic cassette 15 drives the first radiation detector 40 for imaging, and transmits image data from the first radiation detector 40 to the console unit 17 with the radio communication interface 71. The console unit 17 causes the display 176 to display a still image of the input image data.

For diagnosis and treatment of a patient in a cardiology field, a number of physicians or doctors are combined to form a team for the purpose of medical imaging. The team includes an assistant and operator. The assistant adjusts the position of the horizontal table 21 where the patient lies, and rotates the radiation source apparatus 14 for a position of a body part of interest in the patient. The operator views a fluoroscopic image (radiographic image) and manipulates a catheter, guide wire or the like for entry in the body of the patient. As both hands of the operator are occupied because of manipulating the catheter or guide wire, the operator uses the foot switch for changeover between the fluoroscopic imaging and still imaging. The fluoroscopic imaging is used for positioning the patient and searching a lesion. The still imaging is used for sharply forming a radiation image of the lesion with high precision.

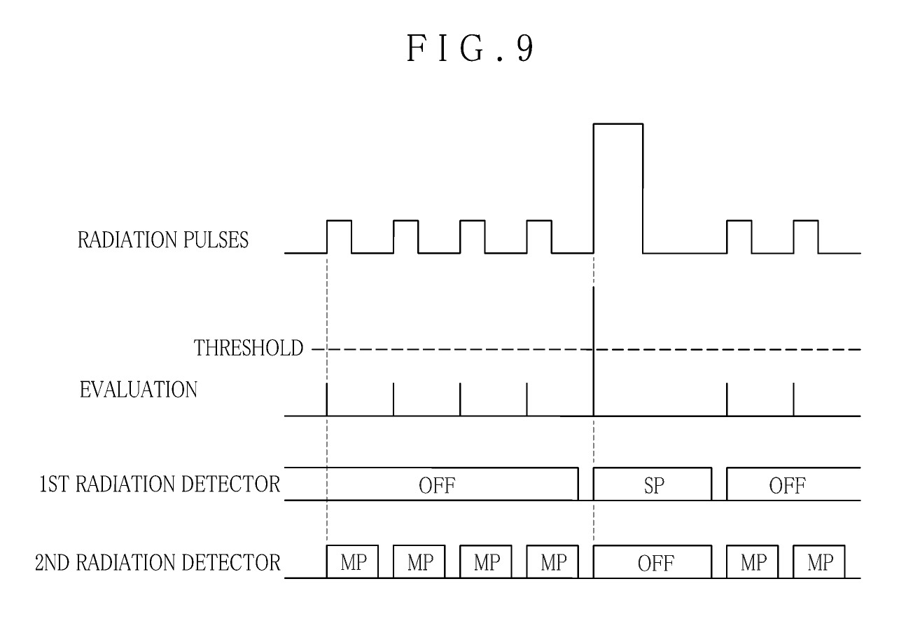

The operation of still imaging started during the fluoroscopic imaging is described by referring to FIG. 9. In the fluoroscopic imaging, the radiation source apparatus 14 emits low dose radiation pulses for fluoroscopic imaging at a predetermined interval toward a body part of a patient. The measurement unit 42 for dosimetry samples the radiation at a shorter interval than the interval of the low dose radiation pulses. The evaluator 75 for the dose compares a radiation dose upon the rise of the radiation measured by the measurement unit 42 for dosimetry with a predetermined threshold, and if the radiation dose is lower than the threshold, determines the low dose radiation pulses.

In case the low dose radiation pulses are detected by the evaluator 75 for the dose, the cassette controller 70 drives the second radiation detector 41 in synchronism with the low dose radiation pulses, to perform a control of fluoroscopic imaging MP. In the fluoroscopic imaging MP, all of the gate wire lines 60 are selected together by the gate line driver 62 to turn on all of the TFTs 342. The charge stored in the capacitor 343 is removed (reset).

Then all of the gate wire lines 60 are designated as unselected elements to turn off all the TFTs 342. The capacitors 343 are in a state of storing charge. The photoconductor 341 generates charge according to radiation transmitted through the body part. The capacitor 343 stores the charge. After emitting low dose radiation pulses, the gate wire lines 60 are driven sequentially by the gate line driver 62. The charge is read out of the capacitor 343, so that the signal processor 63 creates image data.

In the fluoroscopic imaging MP, the cassette controller 70 turns off (OFF) the supply of power or voltage from the power source 77 to the various elements of the first radiation detector 40. Thus, influence of electric noise to the readout of the second radiation detector 41 is reduced.

At each time of detecting a low dose radiation pulse, the fluoroscopic imaging MP is carried out. Image data is transmitted from the image memory 64 by the radio communication interface 71 to the console unit 17 serially. The display 176 displays a fluoroscopic image according to the input image data in the console unit 17.

During the fluoroscopic imaging, still imaging may be instructed upon operating a foot switch or the like. Then the radiation source apparatus 14 emits high dose radiation pulses for the still imaging toward a body part of interest in a body of a patient. The dose of the high dose radiation pulses is approximately 100 times a high as the low dose radiation pulses. The evaluator 75 for the dose compares the radiation dose with a predetermined threshold at the time of the rise of radiation measured by the measurement unit 42 for dosimetry, and if the radiation dose is higher than the threshold, determines high dose radiation pulses.

In case the evaluator 75 for the dose detects the high dose radiation pulses, the cassette controller 70 drives the first radiation detector 40 in synchronism with the high dose radiation pulses, to perform a control of the still imaging SP. In a manner similar to the fluoroscopic imaging MP, the first radiation detector 40 creates image data in the still imaging SP. The image data is transmitted by the radio communication interface 71 to the console unit 17, where the display 176 displays a still image. Note that the still image may be displayed on a display device other than the display 176.

In the still imaging SP, the cassette controller 70 turns off (OFF) the supply of power or voltage from the power source 77 to the various elements of the second radiation detector 41. Thus, influence of electric noise to the readout of the first radiation detector 40 is reduced.

As described heretofore, the still image of high precision can be obtained in the first radiation detector 40 owing to the high density of the arrangement of the pixels 324. In contrast, the fluoroscopic image is obtained at a high frame rate in the second radiation detector 41, because the second radiation detector 41 is driven at a high speed with the low density of the arrangement of the pixels 344 and their small number.

Also, the first and second radiation detectors 40 and 41 are overlapped in the optical path direction OP of the radiation, to set the second radiation detector 41 to detect radiation transmitted through the first radiation detector 40. Thus, still imaging can be carried out rapidly without need of moving the second radiation detector 41 at the time of changeover from the fluoroscopic imaging to the still imaging.

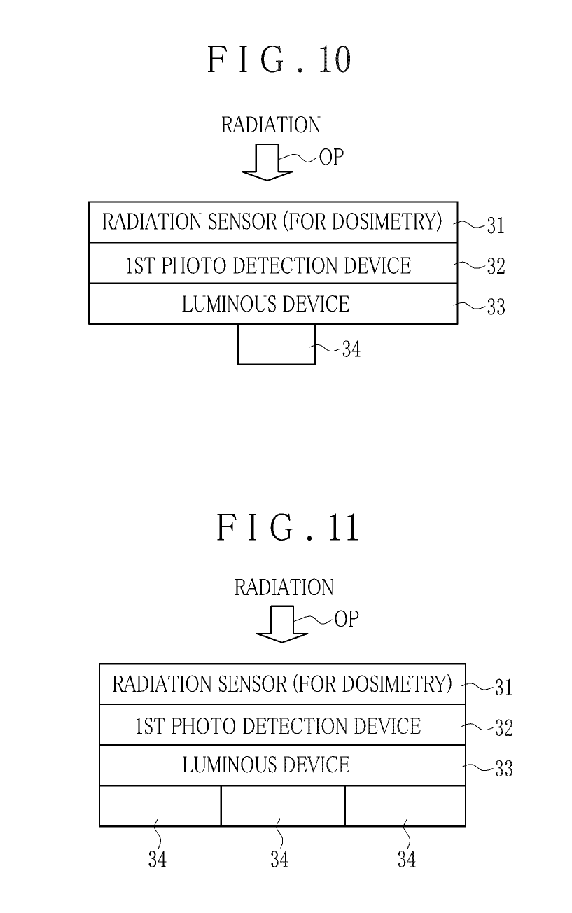

Other preferred embodiments of electronic cassettes are hereinafter described. In FIG. 10, the radiation sensor 31 for dosimetry, the first photo detection device 32 and the luminous device 33 of the above embodiment are repeated but with a difference in that an area of the second photo detection device 34 is smaller (with a smaller density) than that of the luminous device 33 and the first photo detection device 32. It is preferable in the second photo detection device 34 that a pitch of arrangement of the pixels 344 is smaller than that of the pixels 324 of the first photo detection device 32, and thus a density of the arrangement of the pixels 344 is higher. A preferred example of the second photo detection device 34 with the small area is a CMOS image sensor or CCD image sensor constituted by a silicon substrate as a base. Consequently, imaging at a high speed is possible in the second radiation detector 41 at a high number of frames per unit time. Also, it is preferable to use a wide gap semiconductor substrate of silicon carbide (SiC) and the like in place of the silicon substrate. It is technically known that the silicone carbide substrate has approximately 500 times as high resistance to radiation as that of a silicon substrate.

In a structure illustrated in FIG. 11, a plurality of the second photo detection devices 34 with a small area are arranged in a tightly collected manner to define as large an area as the luminous device 33 and the first photo detection device 32. In a radiation image obtained by the second radiation detector 41, there occurs a gap associated with an interval between successive two of the second photo detection devices 34. However, it is possible to process the interval by processing of interpolation. As the radiation image is used as a fluoroscopic image, influence to diagnosis will be minimized.

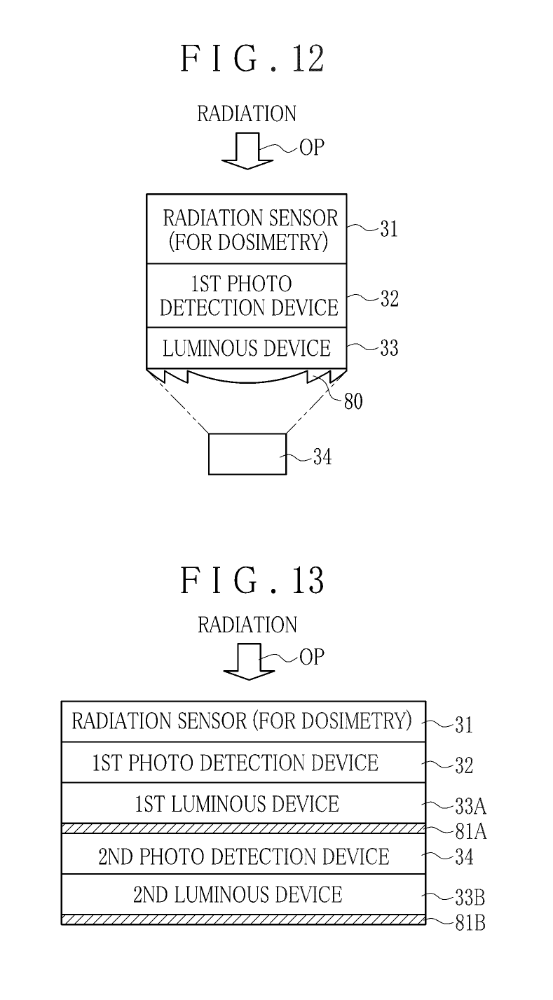

In a structure of FIG. 12, a Fresnel lens 80 is disposed between the second photo detection device 34 of the small area and the luminous device 33. Visible light traveling from the luminous device 33 toward the second photo detection device 34 is condensed by the Fresnel lens 80 and entered in the second photo detection device 34, which can detect a field of view equal to that of the first photo detection device 32.

In a structure illustrated in FIG. 13, the radiation sensor 31 for dosimetry, the first photo detection device 32, a first luminous device 33A, the second photo detection device 34 and a second luminous device 33B are arranged in series in the optical path direction OP of radiation. The first and second luminous devices 33A and 33B are constructed equally to the luminous device 33 described above. In this structure, each one of the first and second radiation detectors 40 and 41 is the ISS type. Preferably, a light reflective layer 81A is formed on a downstream surface of the first luminous device 33A in the optical path direction OP. A light reflective layer 81B is formed on a downstream surface of the second luminous device 33B in the optical path direction OP. The light reflective layers 81A and 81B are formed from metal film of aluminum or the like.

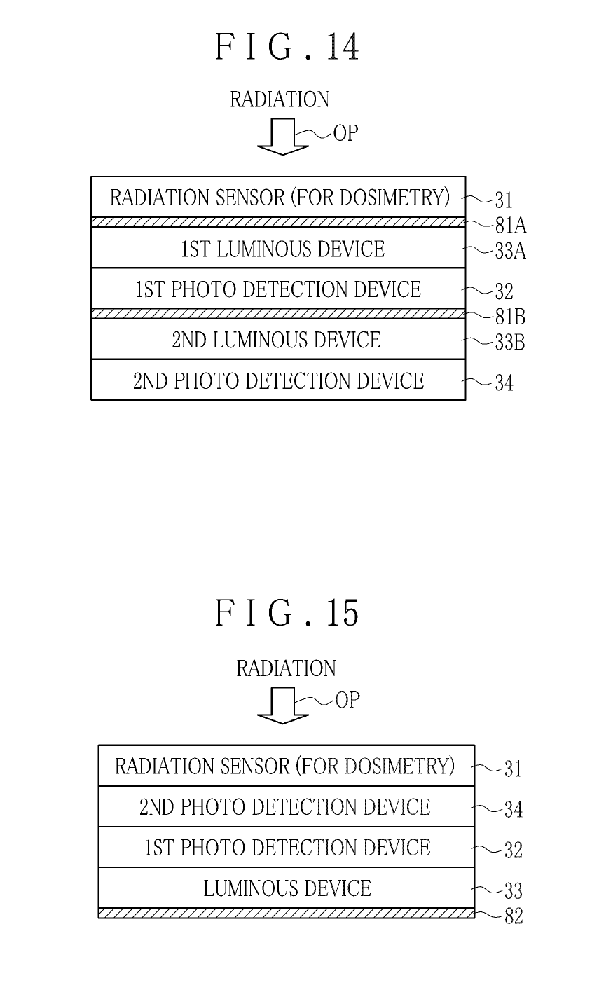

In a structure illustrated in FIG. 14, the radiation sensor 31 for dosimetry, the first luminous device 33A, the first photo detection device 32, the second luminous device 33B and the second photo detection device 34 are arranged in series in the optical path direction OP of radiation. In this structure, each one of the first and second radiation detectors 40 and 41 is the PSS type. Preferably, the light reflective layer 81A is formed on an upstream surface of the first luminous device 33A in the optical path direction OP. The light reflective layer 81B is formed on an upstream surface of the second luminous device 33B in the optical path direction OP.

In a structure illustrated in FIG. 15, the radiation sensor 31 for dosimetry, the second photo detection device 34, the first photo detection device 32 and the luminous device 33 are arranged in series in the optical path direction OP of the radiation. Each one of the first and second radiation detectors 40 and 41 is the ISS type. It is preferable to form the second photo detection device 34 from an organic material in a manner similar to the radiation sensor 31 for dosimetry. Also, a light reflective layer 82 is preferably formed on a downstream surface of the luminous device 33 in the optical path direction OP.

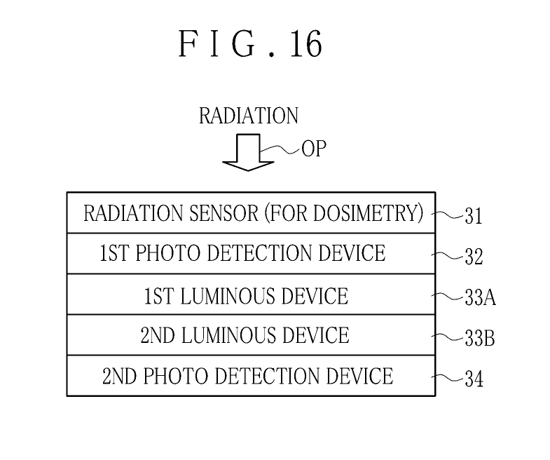

In a structure illustrated in FIG. 16, the radiation sensor 31 for dosimetry, the first photo detection device 32, the first luminous device 33A, the second luminous device 33B and the second photo detection device 34 are arranged in series in the optical path direction OP of the radiation. The first and second luminous devices 33A and 33B are provided in place of the luminous device 33 of FIG. 6. The first radiation detector 40 is the ISS type including the first luminous device 33A and the first photo detection device 32. The second radiation detector 41 is the PSS type including the second luminous device 33B and the second photo detection device 34.

In the structure depicted in FIG. 16, the first and second luminous devices 33A and 33B have phosphor with characteristics different between those. For example, phosphor of a columnar crystal is used for the first luminous device 33A, such as CsI:Tl, CsI:Na and the like with a columnar crystal structure. Phosphor of gadolinium oxide (GOS) is used for the second luminous device 33B. For this structure, it is preferable to oppose a distal end of the columnar crystal structure to the first photo detection device 32 in a manner similar to the construction illustrated in FIG. 5.

The phosphor of columnar crystals is optically advantageous in high resolving power and high performance, but is expensive in comparison with the phosphor of GOS. Thus, the phosphor of columnar crystals is used for the first luminous device 33A of the first radiation detector 40 for still imaging requiring high image quality. The phosphor of GOS is used for the second luminous device 33B of the second radiation detector 41 for fluoroscopic imaging without requiring high image quality. It is possible to reduce the cost without lowering performance suitable for the purpose. The phosphor of columnar crystals, although its resistance to shock is lower locally according to its thickness, can be formed at a small thickness according to the present embodiment. Thus, resistance to shock of the phosphor of columnar crystals can be high.

The phosphor of GOS is mixed with binder resin because of particles of powder. As a resolving power can be increased by forming the phosphor of GOS finely in particles, it is possible to use the phosphor of GOS for the first luminous device 33A and use the phosphor of columnar crystals for the second luminous device 33B in a manner reverse to the above structure. It is preferable to oppose a distal end of the phosphor of columnar crystals to the second photo detection device 34.

The first luminous device 33A having the phosphor of GOS can absorb radiation (X-rays) of higher energy. This is because an atom in the phosphor of GOS has a higher atomic number than an atom in the phosphor of a columnar crystal. This structure is effective specifically in a condition with a difference in a tube voltage of the radiation source 140 between the fluoroscopic imaging and still imaging, and the use of higher tube voltage for the still imaging for the purpose of forming a still image of a high contrast. Also, a radiation dose for the fluoroscopic imaging can be lowered by use of the phosphor of the columnar crystal for the second luminous device 33B. It is possible to minimize exposure of a patient to radiation, because the phosphor of the columnar crystal has higher sensitivity to radiation.

In any of the two examples described above, the phosphor of GOS is formed by coating or adhesion of one of the first and second photo detection devices 32 and 34. The phosphor of columnar crystals is formed by coating or adhesion of a remaining one of the first and second photo detection devices 32 and 34. Examples of the vapor deposition of the phosphor of columnar crystals include direct deposition and indirect deposition. The indirect deposition is a method of depositing the phosphor of columnar crystals on a base plate of the vapor deposition, attaching the phosphor of columnar crystals to the first photo detection device 32 or to the second photo detection device 34, and then peeling the base plate. The attachment between the phosphor of columnar crystals and the phosphor of GOS is carried out by adhesion or pouch packaging in a state of applying pressure between those. Also, the phosphor of columnar crystals may be directly deposited or indirectly deposited on the phosphor of GOS by vapor deposition, and then may be attached to the first photo detection device 32 or to the second photo detection device 34.

In a variant of the embodiments, it is possible to use mixture of the phosphor of GOS of fine particles with binder resin in the first luminous device 33A, and mixture of the phosphor of GOS of large particles with binder resin in the second luminous device 33B. The phosphor of GOS of the large particles has a lower resolving power but higher sensitivity to radiation than the phosphor of GOS of the fine particles. Thus, a fluoroscopic image of a high sensitivity can be created. Note that a light reflection layer can be formed between the first and second luminous devices 33A and 33B in each one of the above embodiments.

In the above embodiments, the photoconductive film 321C of the first photo detection device 32 is constituted by amorphous silicon in the first radiation detector 40. However, the photoconductive film 321C can be constituted by a material containing an organic photoconductive material. For this structure, an absorption spectrum with high absorption mainly in a visible light range is obtained. There occurs very little absorption of electromagnetic waves other than the visible light emitted by the scintillator 332 in the photoconductive film 321C. Accordingly, electric noise created by absorption of radiation in the photoconductive film 321C is suppressed.

The photoconductive film 321C of an organic photoconductive material can be formed on the TFT active matrix substrate plate 32A by use of an ink jet head as an ejection head for fluid droplets. No resistance to heat is required for the insulation board 325 included in the TFT active matrix substrate plate 32A. Thus, it is possible to select a material for the insulation board 325 from alternative substances other than glass.

As the photoconductive film 321C is constituted by the organic photoconductive material for photoelectric conversion, very little absorption of radiation occurs in the photoconductive film 321C. Attenuation of the radiation due to passage through the first photo detection device 32 is suppressed. Consequently, forming the photoconductive film 321C from the organic photoconductive material is typically preferable in the case of the ISS type of the first radiation detector 40.

A peak absorption wavelength of the organic photoconductive material constituting the photoconductive film 321C is preferably near to a peak absorption wavelength of the scintillator 332, for the purpose of efficiently absorbing visible light emitted by the scintillator 332 with optimized efficiency. The peak absorption wavelength of the organic photoconductive material should be ideally equal to that of the scintillator 332. However, a difference in the peak absorption wavelength between those can be preferably small so as to absorb visible light emitted from the scintillator 332 sufficiently. Specifically, a difference between the peak absorption wavelength of the organic photoconductive material and that of the scintillator 332 is equal to or less than 10 nm, and preferably equal to or less than 5 nm.

Examples of organic photoconductive materials satisfying these conditions are quinacridone organic compounds and phthalocyanine organic compounds. A peak absorption wavelength of quinacridone in the visible light range is 560 nm. Thus, thallium-activated cesium iodide (CsI:Tl) is used as a material of the scintillator 332 in combination with a quinacridone compound as an organic photoconductive material. It is possible to reduce a difference in the peak absorption wavelengths to 5 nm or lower. An amount of electric charge generated by the scintillator 332 can be maximized.

Preferably, the photoconductive film 321C contains a p-type organic compound or n-type organic compound. The p-type organic compound is a donor organic semiconductor such as hole transport organic compound, and has an electron donating property. More precisely, the p-type organic compound is one of two organic compounds having a lower ionization potential in case those are used in contact with one another. Any one example of donor organic semiconductor having an electron donating property can be used. The n-type organic compound is an organic acceptor semiconductor such as electron transport organic compound, and has an electron accepting property. More precisely, the n-type organic compound is one of two organic compounds having a higher electron affinity in case those are used in contact with one another. Any one example of organic acceptor semiconductor having an electron accepting property can be used.

Note that the photoconductor 321 can include at least the first and second electrodes 321A and 321B and the photoconductive film 321C. However, it is preferable to dispose at least any one of the an electron blocking film and hole blocking film for positive holes between the photoconductive film 321C and the first and second electrodes 321A and 321B in order to suppress an increase in the dark current. It is further preferable to dispose both of the electron blocking film and hole blocking film.

An example of active layer of the thin film transistor 322 is a non-crystalline oxide containing at least one of In, Ga and Zn, for example, In—O compound, and preferably a non-crystalline oxide containing at least two of In, Ga and Zn, for example, In—Zn—O compound, In—Ga—O compound and Ga—Zn—O compound, and the most preferably a non-crystalline oxide containing In, Ga and Zn. An example of In—Ga—Zn—O compound as non-crystalline oxide is that of which a crystalline form is expressed in a formula of InGaO₃(ZnO)ₘ where m is a positive integer less than 6, and also that which satisfies a condition m=4.

Also, the active layer of the thin film transistor 322 can be formed from an organic semiconductor material. Examples of organic semiconductor materials include phthalocyanine compounds disclosed in U.S. Pat. No. 7,768,002 (corresponding to JP-A 2009-212389), pentacene, vanadyl phthalocyanine, and the like.

Forming the active layer of the thin film transistor 322 from a non-crystalline oxide or organic semiconductor material effectively suppresses occurrence of electric noise, because radiation such as X-rays is not absorbed, or is absorbed very slightly.

Also, the active layer in the thin film transistor 322 can be formed from carbon nanotubes. As a result, a switching speed of the thin film transistor 322 can be made high. Also, an amount of the absorption of light of a visible light range in the thin film transistor 322 can be lowered. Note that it is necessary centrifugally to separate and extract carbon nanotubes with very high purity for use in forming the active layer, because performance of the thin film transistor 322 would be remarkably lower in the case of mixture of metallic impurity in the active layer even at a very fine amount.

The various materials for use can be formed into film at a low temperature, including a non-crystalline oxide or organic semiconductor material constituting the active layer of the thin film transistor 322, and an organic semiconductor material constituting the photoconductive film 321C. Accordingly, the insulation board 325 can be constituted by a flexible substrate of a synthetic resin, aramid, bionanofibers and the like in addition to a quartz substrate, glass substrate and the like. Specific examples of materials for the flexible substrate include polyesters, such as polyethylene terephthalate, polybutylene phthalate and polyethylene naphthalate, and polystyrene, polycarbonate, polyether sulfonate, polyarylate, polyimide, polycycloolefin, norbornene resin, and poly(chloro trifluoro ethylene). It is also possible to reduce the weight by use of such synthetic resin for the flexible substrate. Note that it is possible to form additional layers on the insulation board 325, including an insulating layer for insulation, a gas barrier layer for preventing permeation of water or oxygen, and an undercoat layer for keeping flatness or tightness in contact with electrodes.

Also, bionanofibers are a composite material formed from a bundle of cellulose microfibrils (bacteria cellulose) produced by bacteria (Acetobacter xylinum) and transparent resin. The bundle of the cellulose microfibrils has a width of 50 nm which is 1/10 as large a size as a wavelength of visible light, and also has high strength, high resiliency and a low coefficient of thermal expansion. Transparent resin such as acrylic resin, epoxy resin and the like is impregnated in the bacteria cellulose and hardened, so that bionanofibers are obtained inclusive of fibers of 60-70% and light transmittance of approximately 90% at a wavelength of 500 nm. The bionanofibers have a low coefficient of thermal expansion (3-7 ppm) in the manner near to silicon crystals, has as high strength (460 MPa) and as high resiliency (30 GPa) as steel, and is flexible. Consequently, the thickness of the product can be reduced in comparison with a glass substrate or the like.

Furthermore, it is possible to construct the second photo detection device 34 in the same manner as the first photo detection device 32 described above.

In the above embodiments, any one of the first and second radiation detectors 40 and 41 and the measurement unit 42 for dosimetry is a radiation detector of an indirect conversion type in which radiation is photoelectrically converted by the scintillator into visible light, which is converted into electric charge. However, it is possible to use a radiation detector of a direct conversion type in which radiation is converted into electric charge by a photoconductive layer of amorphous selenium or the like.

Although the radiation sensor 31 for dosimetry is disposed upstream of the first and second photo detection devices 32 and 34 in the optical path direction OP, the radiation sensor 31 for dosimetry can be disposed downstream of the first and second photo detection devices 32 and 34 in the optical path direction OP. Also, the radiation sensor 31 for dosimetry can be assembled together with the first photo detection device 32 or the second photo detection device 34.

In the above embodiments, the first and second radiation detectors 40 and 41 are in the plate shape, substantially parallel with one another, and arranged in the optical path direction OP. The second radiation detector 41 of the embodiments has the size equal to or smaller than that of the first radiation detector 40. However, sizes of the first and second radiation detectors 40 and 41 are not limited to the embodiments described heretofore.

In the above embodiments, the radiation source apparatus 14 outputs radiation at a dose according to a command signal from the console unit 17. The electronic cassette 15 evaluates the dose of detected radiation by mean of the evaluator 75 for the dose. However, it is possible for the console unit 17 to send the command signal for the dose also to the electronic cassette 15, and to evaluate the radiation emitted by the radiation source apparatus 14 for any one of high and low doses.

In the embodiment of FIG. 16, the phosphors of the plural examples are used for the first and second luminous devices 33A and 33B. In the example of using the phosphor of a columnar crystal in the first luminous device 33A, the still imaging can be carried out at a high image quality. In the example of using the phosphor of a columnar crystal in the second luminous device 33B, the fluoroscopic imaging can be carried out at a low dose. Furthermore, it is possible to combine the use of the phosphors or the plural examples with each one of the embodiments of FIGS. 13 and 14.

In the above embodiments, the radiographic imaging apparatus has the electronic cassette. Instead, a radiation detector in a radiographic imaging apparatus according to the invention can be a mammography device and other medical apparatuses.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiographic imaging apparatus comprising:
a first radiation detector for detecting radiation emitted by a radiation source, and creating image data;
a second radiation detector for detecting said radiation transmitted through said first radiation detector, and creating image data;
a controller for controlling said first and second radiation detectors, to operate said first radiation detector for still imaging, and to operate said second radiation detector for fluoroscopic imaging.

2. A radiographic imaging apparatus as defined in claim 1, further comprising:
a measurement unit for measuring a dose of radiation pulses of said radiation emitted by said radiation source;
an evaluator for comparing said dose measured by said measurement unit to a predetermined threshold;
wherein said controller, if said dose of said radiation pulses is found lower than said threshold by said evaluator, operates said second radiation detector for fluoroscopic imaging, and if said dose of said radiation pulses is found higher than said threshold by said evaluator, operates said first radiation detector for still imaging.

3. A radiographic imaging apparatus as defined in claim 2, wherein each of said first and second radiation detectors has plural pixels;
arrangement density of said pixels of said second radiation detector is lower than arrangement density of said pixels of said first radiation detector.

4. A radiographic imaging apparatus as defined in claim 3, wherein a pixel number of said pixels of said second radiation detector is smaller than a pixel number of said pixels of said first radiation detector.

5. A radiographic imaging apparatus as defined in claim 4, wherein a frame rate of said second radiation detector is higher than a frame rate of said first radiation detector.

6. A radiographic imaging apparatus as defined in claim 5, wherein a field of view of said second radiation detector is smaller than a field of view of said first radiation detector.

7. A radiographic imaging apparatus as defined in claim 1, wherein said first radiation detector includes a luminous device for emitting visible light by absorbing said radiation, and a first photo detection device disposed upstream of said luminous device in an optical path direction of said radiation for detecting said visible light emitted by said luminous device;
said second radiation detector includes said luminous device, and a second photo detection device disposed downstream of said luminous device in said optical path direction for detecting said visible light emitted by said luminous device.

8. A radiographic imaging apparatus as defined in claim 7, wherein said luminous device contains phosphor of a columnar crystal, and a distal end of said phosphor of said columnar crystal is opposed to said first photo detection device.

9. A radiographic imaging apparatus as defined in claim 8, wherein an area of said second photo detection device is smaller than an area of said luminous device.

10. A radiographic imaging apparatus as defined in claim 9, wherein each of said first and second radiation detectors has plural pixels;
arrangement density of said pixels of said second radiation detector is lower than arrangement density of said pixels of said first radiation detector.

11. A radiographic imaging apparatus as defined in claim 10, wherein said second photo detection device is a CMOS image sensor or CCD image sensor.

12. A radiographic imaging apparatus as defined in claim 9, further comprising a Fresnel lens, disposed between said luminous device and said second photo detection device, for condensing said visible light from said luminous device toward said second photo detection device.

13. A radiographic imaging apparatus as defined in claim 1, wherein said first radiation detector includes a first luminous device for emitting visible light by absorbing said radiation, and a first photo detection device disposed upstream of said first luminous device in an optical path direction of said radiation for detecting said visible light emitted by said first luminous device;
said second radiation detector includes a second luminous device for emitting visible light by absorbing said radiation transmitted through said first luminous device and said first photo detection device, and a second photo detection device disposed downstream of said second luminous device in said optical path direction for detecting said visible light emitted by said second luminous device.

14. A radiographic imaging apparatus as defined in claim 13, wherein one of said first and second luminous devices has phosphor of a columnar crystal, and a remaining one of said first and second luminous devices has phosphor of gadolinium oxide.
